(19) United States
(12) Patent Application Publication
(10) Pub. No.: US 2026/0171468 A1
(43) Pub. Date: Jun. 18, 2026

(54) REDOX FLOW BATTERY

(71) Applicant: GREEN ENERGY STORAGE S.R.L., Trento (IT)

(72) Inventors: Ilaria PUCHER, Trento (IT); Eneko AZACETA, Trento (IT); Elisa MUSELLA, Trento (IT)

(73) Assignee: GREEN ENERGY STORAGE S.R.L., Trento (IT)

(21) Appl. No.: 18/869,518

(22) PCT Filed: May 27, 2022
(86) PCT No.: PCT/EP2022/064423

§ 371 Date: Nov. 26, 2024

(51) Int. Cl. H01M 10/052; H01M 8/04186; H01M 8/18; H01M 8/20

(52) U.S. Cl. CPC H01M 10/052; H01M 8/04186; H01M 8/188; H01M 8/20

(57) ABSTRACT

The invention relates to a redox flow battery, to an energy storage system including said redox flow battery, as well as to methods for delivering and/or storing electricity by means of said redox flow battery.

### FIELD OF THE INVENTION

The invention relates to a redox flow battery, to an energy storage system including said redox flow battery, as well as to methods for delivering and/or storing electricity by means of said redox flow battery.

### BACKGROUND

Global energy demand doubles every 15 years, and it is forecasted to keep on increasing in the next future with a parallel growing and urgent demand of high-energy resources.

However, more than 60% of the global electrical energy is produced from coal and from natural gas with an associated huge emission of CO₂, which is considered the main contributor to greenhouse effect and global warming.

Because of such detrimental environmental effects, replacing fossil fuels with renewable energy sources—primarily with wind and solar energy—has become imperative. The most relevant problem is that they are intermittent and cannot guarantee a continuous flow of energy. Since our reliance on renewable energy needs to grow, there is an increasing need to store it for times when energy cannot be harvested.

Among possible alternatives, electrochemical storage and conversion plays a key role. Researchers are focusing their attention on finding new materials in order to boost performance: environmental sustainability is essential considering the urgent need for large-scale production and diffusion.

Redox flow batteries (RFBs) offer a unique advantage of energy and power independence. RFBs consist of tanks of electrolyte that store chemical energy and electrochemical cells that reversibly convert chemical energy into electrical energy.

Various types of RFBs have been developed up to now, and they can be classified into two types according to the electrolyte: aqueous and non-aqueous RFBs. Aqueous ones offer advantages in terms of safety, toxicity, and cost over their non-aqueous counterparts.

Although the energy storage systems that use aqueous RFBs are the subject of considerable and ever-increasing interest given their potential, to date the Applicant has found that significant technological and functional limits remain in this sector.

Among various redox active species for RFBs, manganese-based RFBs have attracted attention in view of the highly interesting characteristics of manganese as redox active species, through the following one-electron mechanism (Eq. 1)

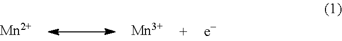

which has a high redox potential of 1.51 V (vs SHE) and thanks also to its high solubility in, allowing to obtain a high energy density.

Manganese-based RFBs, however, suffer as main drawback the formation of solid MnO₂ in the electrolyte, which takes places naturally by Mn³⁺ disproportionation or electrochemically. Solid MnO₂ tends to precipitate, subtracting the active species to the redox reaction and causing detrimental consequences for the functioning of the RFB (cluggings, deposits on the electrode surface), that lead to a loss of efficiency of the RFB with time.

To date, several strategies to suppress MnO₂ formation in a battery are known, among which the use of additives to suppress MnO₂ formation by Mn³⁺ disproportionation and limiting the charge process to 90% SOC are the most widespread.

Another strategy found in literature describes a Mn system exploiting MnO₂ formation in a controlled way. For that, electrolyte formulation and electrode properties are designed to promote MnO₂ plating/stripping. In other words, MnO₂ is electrochemically deposited on the electrode during charge and electrochemically dissolved during discharge, according to a two-electron mechanism (Eq. 2):

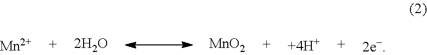

However, plating/stripping is a limiting mechanism for redox flow batteries in terms of power and energy decoupling. Generally, redox flow batteries show a power to energy ratio that can be adjusted by sizing the electrolyte amount (energy) and sizing the cell stack (Power). This flexibility is not applicable in systems where plating takes place. In systems where the platted compound is isolating, such as MnO₂, the energy will be limited by the electrode surface area, as the electrochemical reactions will be blocked when a complete coating of the electrode surface takes place. This strongly limits the possibility of exploiting MnO₂ platting/striping systems in redox flow batteries.

The Applicant observed that such strategies present several technological and functional limits and surprisingly found out that a completely different mechanism may be exploited in a manganese-based electrolyte for the functioning of a RFB.

### SUMMARY OF INVENTION

A first object of the present invention is therefore to provide a manganese-based redox flow battery capable of overcoming the technological limits of the prior art.

In accordance with the present invention, the Applicant has in fact surprisingly found out that a specific manganese-based positive electrode electrolyte unleashes a reversible two-electron redox mechanism (Eq. 2):

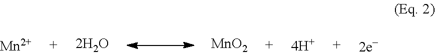

generating a stable suspension of manganese(IV) species in the electrolyte. Said manganese(IV) species comprises, or consists of, MnO₂, advantageously in the form of particles suspension.

The electrochemical exploitation of such reversible two-electron redox mechanism, avoiding the detrimental effect of precipitation, is of high interest as it provides a two-fold energy density, among other benefits, in comparison with one-electron mechanism (Eq. 1) at the same electrolyte cost, and shows a decoupled power/energy performance unlike MnO₂ plating/stripping mechanism.

Therefore, in a first aspect the present invention relates to a redox flow battery in which a positive electrode electrolyte and a negative electrode electrolyte are supplied to a battery cell including a positive electrode, a negative electrode, a membrane interposed between electrodes, to charge and discharge the battery, wherein:
said positive electrode electrolyte comprises at least one manganese ion and at least one complexing agent selected from the group consisting of: a titanium ion, a tin ion, a chromium ion, an aluminum ion, a vanadium ion, a cerium ion, or mixtures thereof;
said negative electrode electrolyte comprises at least one active redox species that couples with the manganese ion of the positive electrode electrolyte; and
said positive electrode is a thermally activated carbon-based electrode.

The operating principle of the redox flow battery according to the present invention is based on the manganese redox mechanism. The Applicant surprisingly found out that the detrimental effect of the MnO₂ precipitation in the electrolyte and the limiting effect of the surface area of the cathode of the MnO₂ plating/stripping mechanism may be avoided and rather a stable manganese(IV) species can be advantageously generated and maintained in the electrolyte during the functioning of the RFB by using a complexing agent selected from the group consisting of: a titanium ion, a tin ion, a chromium ion, an aluminum ion, a vanadium ion, a cerium ion, or mixtures thereof and wherein the positive electrode is a thermally activated carbon-based electrode. Such conditions indeed allow unleashing and exploiting a reversible two-electron redox mechanism (Eq. 2) which provides a two-fold energy density compared to the one-electron redox mechanism (Eq. 1) with the same quantity of manganese species, while avoiding energy capacity limitation related to MnO₂ plating/striping mechanism, thus improving efficiency and cost effectiveness of the RFB.

In a further aspect, the present invention relates also to an energy storage or delivery system comprising at least one redox-flow battery according to the first aspect of the present invention and at least one connection means apt to connect said at least one redox-flow battery to an external power source or to a load.

The advantages of the energy storage or delivery system according to this further aspect have been already outlined with reference to the above redox flow battery according to the first aspect of the invention and are not repeated herewith.

### BRIEF DESCRIPTION OF THE DRAWINGS

In the drawings:

FIG. 1 schematically shows the redox flow battery used in the experiments according to Examples 1-11;

FIG. 2 shows the first charge/discharge cycle obtained with the experiment according to Example 1;

FIG. 3 shows the visual appearance of the Mn-based catholyte during the charge and discharge process of the experiment according to Example 1;

FIG. 4 shows the first 7 charge/discharge cycles obtained with the experiment according to Example 2;

FIG. 5 shows the first 7 charge/discharge cycles obtained with the experiment according to Example 3;

FIG. 6 shows the first 7 charge/discharge cycles obtained with the experiment according to Example 4;

FIG. 7 shows the comparison of the performances of the RFB according to the invention (Example 2), with the reference systems (Example 3 and 4—reference examples);

FIG. 8 shows FE-SEM micrographs of the electrodes after battery charging of examples 2, 3 and 4;

FIG. 9 shows the charge/discharge cycles obtained with the experiments according to Example 6 (9a); Example 7 (9b) and Example 8 (9c).

FIG. 10 shows the charge/discharge cycle obtained with the experiments according to Example 9.

FIG. 11 shows the charge/discharge cycles obtained with the experiments according to Example 10 and reference example 11.

### DETAILED DESCRIPTION OF THE INVENTION

In a first aspect, the present invention relates to a redox flow battery invention in which a positive electrode electrolyte and a negative electrode electrolyte are supplied to a battery cell including a positive electrode, a negative electrode, a membrane interposed between electrodes, to charge and discharge the battery, wherein:
said positive electrode electrolyte comprises at least one manganese ion and at least one complexing agent selected from the group consisting of: a titanium ion, a tin ion, a chromium ion, an aluminum ion, a vanadium ion, a cerium ion, or mixtures thereof;
said negative electrode electrolyte comprises at least one active redox species that couples with the manganese ion of the positive electrode electrolyte; and
said positive electrode is a thermally activated carbon-based electrode.

The operating principle of the redox flow battery according to the present invention is based on the manganese redox mechanism. The Applicant surprisingly found out that the detrimental effect of the MnO₂ precipitation in the electrolyte and the limiting effect of the surface area of the cathode of the MnO₂ plating/stripping mechanism may be avoided and rather a stable manganese(IV) species can be advantageously generated and maintained in the electrolyte during the functioning of the RFB according to the invention. This allows to unleash and exploit a reversible two-electron redox mechanism (Eq. 2) which provides a two-fold energy density compared to the one-electron redox mechanism (Eq. 1) with the same quantity of manganese species, while avoiding energy capacity limitation related to MnO₂ plating/striping mechanism, thus improving efficiency and cost effectiveness of the RFB.

Within the framework of the present description and in the subsequent claims, except where otherwise indicated, all the numerical entities expressing amounts, parameters, percentages, and so forth, are to be understood as being preceded in all instances by the term “about”. Also, all ranges of numerical entities include all the possible combinations of the maximum and minimum values and include all the possible intermediate ranges, in addition to those specifically indicated herein below.

The present invention may present in one or more of the above aspects one or more of the characteristics disclosed hereinafter.

In the redox flow battery of the present invention, a positive electrode electrolyte and a negative electrode electrolyte are supplied to a battery cell.

Preferably, said positive electrode electrolyte and said negative electrode electrolyte are aqueous electrolytes.

The positive electrode electrolyte comprises at least one manganese ion.

Preferably, said positive electrode electrolyte comprises said at least one manganese ion in a concentration of from 0.1 M to 4.2 M, more preferably in a concentration of from 1 M to 3.5 M, even more preferably in a concentration of from 1.5 M to 3 M.

Advantageously, in said positive electrode electrolyte the redox reaction of said at least one manganese ion is

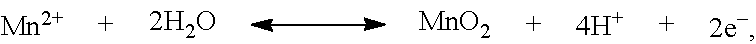

and hence, manganese(IV)-containing species are generated during battery charge and depleted during battery discharge.

Preferably, said positive electrode electrolyte comprises a manganese(IV)-containing species. Preferably, said manganese(IV)-containing species is MnO₂.

Depending on the state of charge of the redox flow battery according to the invention, said manganese(IV)-containing species form a suspension of particles.

Preferably, said positive electrode electrolyte comprises said at least a complexing agent in a concentration of from 0.1 M to 8 M, more preferably in a concentration of from 0.25 M to 6 M, even more preferably in a concentration of from 0.5 M to 5 M.

Preferably, the molar ratio between said at least one manganese ion and said at least a complexing agent ranges from 0.1 to 2, more preferably from 0.25 to 1.5.

The positive electrode electrolyte comprises also at least one complexing agent selected from the group consisting of: a titanium ion, a tin ion, a chromium ion, an aluminum ion, a vanadium ion, a cerium ion, or mixtures thereof.

Preferably, said at least a complexing agent comprises a titanium ion or a tin ion.

Preferably, said at least one titanium ion is selected from the group consisting of: trivalent titanium ion (Ti³⁺) and tetravalent titanium ion (Ti⁴⁺ or TiO²⁺).

Preferably, said titanium ion is a tetravalent titanium ion (Ti⁴⁺ or TiO²⁺).

Preferably, said at least one tin ion is selected from the group consisting of: divalent tin ion (Sn²⁺) and tetravalent tin ion (Sn⁴⁺).

Said tetravalent tin ion can be advantageously added to the electrolyte as such, or prepared in situ, by adding to the electrolyte a divalent tin ion and oxidizing it to tetravalent tin (referred to also as “tin(IV)”) using a chemical oxidation method, an electrochemical oxidation method or any alternative process known to the skilled person.

Said electrolyte may further advantageously contain at least one solvation agent, for example acetonitrile.

In a preferred embodiment, therefore, the present invention refers to a redox flow battery wherein the positive electrode electrolyte comprises at least one manganese ion and at least one tetravalent tin ion.

In a further preferred embodiment, the present invention refers therefore also to a redox flow battery wherein the positive electrode electrolyte comprises at least one manganese ion and at least one tin ion selected from divalent tin ion and tetravalent tin ion and at least one solvation agent, preferably acetonitrile.

Preferably, in the redox flow battery according to the invention, the positive electrode electrolyte has a pH of from 0 to 2.

Preferably, said positive electrode electrolyte comprises at least one acid in a concentration equal to or lower than 4 M, more preferably in a concentration equal to or lower than 3.5 M, even more preferably in a concentration equal to or lower than 3 M.

Preferably, said at least one acid is selected from the group consisting of: sulfuric acid, hydrochloric acid, phosphoric acid, diphosphoric acid, and nitric acid. More preferably, said at least acid is sulfuric acid (H₂SO₄).

The positive electrode electrolyte of the RFB according to the present invention advantageously comprises also at least one anion, in such quantity as to maintain the charge balance of the electrolyte. Said anion is preferably selected from the group consisting of SO₄²⁻, Cl⁻, Br⁻, PO₄²⁻⁻, P₂O₇⁴⁻ and NO₃⁻.

The positive electrode electrolyte of the RFB according to the present invention may also comprise further components, such as suspension stabilizers, cosolvents, organic solvents, surfactants, wetting and dispersing agents. The negative electrode electrolyte of the redox flow battery according to the invention comprises at least one active redox species that couples with the manganese ion of the positive electrode electrolyte.

As the skilled person knows, to ensure a high energy density, the redox potential difference between negative electrode electrolyte and positive electrode electrolyte should advantageously be as high as possible.

Preferably, said at least one active redox species of the negative electrode electrolyte is selected from the group consisting of: a proton, a nickel ion, a cobalt ion, an iron ion, a lead ion, a copper ion, a sulfur ion, a sulfide ion, a zinc ion, a titanium ion, a vanadium ion, a tin ion, a cerium ion, a chromium ion, an iron ion, quinones derivatives thereof, anthraquinones or derivatives thereof, viologens or derivatives thereof, indigo or derivatives thereof, naphtalenediimide or derivatives thereof, diazaanthracenedione or derivatives thereof.

Preferably, said at least one active redox species of the negative electrode electrolyte has an E° of at least 0.6V lower than the E° of reaction:

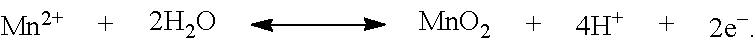

Preferably, said at least one active redox species of the negative electrode electrolyte is a proton and in said negative electrode electrolyte the redox reaction of said proton is

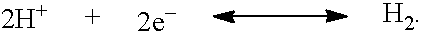

As the skilled person knows, basic construction components of a redox flow battery are battery cell including a positive electrode, a negative electrode, a membrane interposed between electrodes. Said components have features and may be assembled according to well-known common praxis in the relevant art for carrying out its charging/discharging operations.

In the redox flow battery according to the invention, the positive electrode is a thermally activated carbon-based electrode.

The Applicant indeed surprisingly found out that the thermally activated carbon-based electrode synergistically works with the complexing agents according to the invention, allowing to unleash and exploit a reversible two-electron redox mechanism (Eq. 2) which provides a two-fold energy density compared to the one-electron redox mechanism (Eq. 1) with the same quantity of manganese species, while avoiding energy capacity limitation related to MnO₂ plating/striping mechanism, thus improving efficiency and cost effectiveness of the RFB.

Without willing to be bound to any specific theory, the Applicant believes the thermal activation to confer to the carbon-based electrode physicochemical and surface properties capable of synergistically interacting with the complexing agents for generating and maintaining in the electrolyte a stable manganese(IV) species during the functioning of the RFB. The Applicant also believes the same kind of synergy to be obtainable with other activation techniques, for example physicochemical activation, as long as they are capable of conferring such physicochemical and surface properties to the carbon-based electrode.

Preferably, said thermally activated carbon-based electrode is selected from the group of: a graphite-felt, a carbon felt, a graphite cloth, a graphite nanoparticle, a graphite nanofiber, a carbon cloth, a carbon nanotube, a carbon nanoparticle, or a carbon nanofiber thermally activated electrode.

In a preferred embodiment, said thermally activated carbon electrode is a graphite-felt thermally activated electrode.

Preferably, the positive electrode is coupled with at least one flow-by type flow field.

Preferably, said flow-by type flow field includes a channel design selected from the group consisting of: single serpentine channel design, multiple serpentine channel design, and parallel channel design.

In a still further aspect, the present invention relates also to an energy storage or delivery system comprising at least one redox-flow battery according to the first aspect of the present invention and at least one connection means apt to connect said at least one redox-flow battery to an external power source or to a load.

The advantages of the energy storage or delivery system according to this further aspect have been already outlined with reference to the above redox flow battery according to the first aspect of the invention and are not repeated herewith.

In further aspects, the present invention relates also to a method of storing electricity by means of the redox-flow battery according to the present invention, and to a method of delivering electricity by means of the redox-flow battery according to the present invention.

In particular, the present invention relates also to a method of storing electricity comprising the steps of:
a) providing a redox-flow battery according to the present invention;
b) electrically connecting said redox-flow battery to a power source;
and to a method of delivering electricity comprising the steps of:
a) providing a redox-flow battery according to according to the present invention;
b) electrically connecting said redox-flow battery to a load.

The advantages of the methods according to these further aspects have been already outlined with reference to the above redox flow battery according to the first aspect of the invention and are not repeated herewith.

In a still further aspect, the present invention relates also to the use of a thermally activated carbon-based electrode in combination with at least one complexing agent selected from the group consisting of: a titanium ion, a tin ion, a chromium ion, an aluminum ion, a vanadium ion, a cerium ion, or mixtures thereof, for suppressing the precipitation of MnO₂ in an electrolyte comprising at least one manganese ion during the functioning of a redox flow battery in which a redox reaction of said manganese ion in said electrolyte is

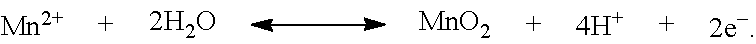

The advantages of the use according to this further aspect have been already outlined with reference to the above redox flow battery according to the first aspect of the invention and are not repeated herewith.

Preferably, in said use said thermally activated carbon-based electrode is selected from the group of: a graphite-felt, a carbon felt, a graphite cloth, a graphite nanoparticle, a graphite nanofiber, a carbon cloth, a carbon nanotube, a carbon nanoparticle, or a carbon nanofiber thermally activated electrode. More preferably, in said use said thermally activated carbon-based electrode is a graphite-felt thermally activated electrode.

Preferably, in said use said complexing agent comprises a titanium ion or a tin ion.

Preferably, said at least one titanium ion is selected from the group consisting of: trivalent titanium ion (Ti³⁺) and tetravalent titanium ion (Ti⁴⁺ or TiO²⁺).

Preferably, said titanium ion is a tetravalent titanium ion (Ti⁴⁺ or TiO²⁺).

Preferably, said at least one tin ion is selected from the group consisting of: divalent tin ion (Sn²⁺) and tetravalent tin ion (Sn⁴⁺).

Preferably, said tin ion is a tetravalent tin ion.

Preferably, in said use said electrolyte comprises said at least one complexing agent in a concentration of from 0.25 M to 6 M, more preferably from 0.5 M to 5 M.

Preferably, in said use the molar ratio between said at least one manganese ion and said at least a complexing agent ranges from 0.1 to 2, more preferably from 0.25 to 1.5.

Features and advantages of the invention will also appear more clearly from the following non-limiting examples.

### Experimental Part

The following electrochemical experiments according to Examples 1-11 were carried out in a H₂—Mn redox flow battery. In the redox flow battery used for the experiments, hydrogen was used as source of protons in the negative electrode electrolyte with the redox reaction:

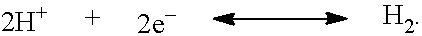

In this way, during charge, H₂ was generated in the electrochemical cell. Gas bubbling revealed H₂ generation during charge. During discharge, H₂ was flowed into the cell at 1.5 bar of pressure.

The positive electrode electrolyte was formulated in the range of 0.3-1.5 M MnSO₄·H₂O (Sigma-Aldrich; 99.0%) and TiOSO₄ (Sigma-Aldrich; ≥29% Ti (as TiO₂) basis, technical) with a Mn:Ti molar ratio of 1:1.5. The 3 M of H₂SO₄ (Fisher scientific, 96%) was used in Examples 1-7, whereas in Example 8 an electrolyte consisting of 2M MnSO₄·H₂O, 1M TiOSO₄ and 2 M of H₂SO₄ was used. In example 9, 0.3 M MnSO₄—H₂O and 0.45 M SnCl₄·5H₂O (Fischer; 98%) and 3 M of H₂SO₄. In the experiments 20 mL of aqueous electrolyte were used and pumped at 100 mL/min.

In example 10, named as Sn(IV), is prepared in the following way: a solution of 0.5 M MnSO₄, 20% v/v acetonitrile in deionized water, 23 mL, is charged to 225 mAh at 22 mA/cm² to generate Mn³⁺ species. Then SnSO₄ 0.125 M (Fisher Scientific, 95%) was added and, from the reaction between Mn³⁺ and Sn²⁺, Mn²⁺ and Sn⁴⁺ were generated. The Sn(IV) electrolyte contains 0.5 M MnSO₄·H₂O; 0.125 M Sn(IV); H₂SO₄ 3 M in 20% VN acetonitrile/deionized water. 23 mL of this electrolyte has been cycled at 43 mA/cm² current density and 100 mL/min flow rate.

The electrolyte in Example 11 (reference example), named as Sn-free electrolyte, is composed by 0.5 M MnSO₄, 3 M H₂SO₄ and 20% vN acetonitrile/deionized water. 20 mL of this electrolyte has been cycled at 0.43 mA/cm² current density at 100 mL/min flow rate.

The nominal capacity, calculated for the reversible two-electron redox mechanism (Eq. 2):

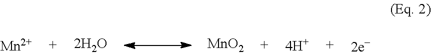

was taken as reference in each case.

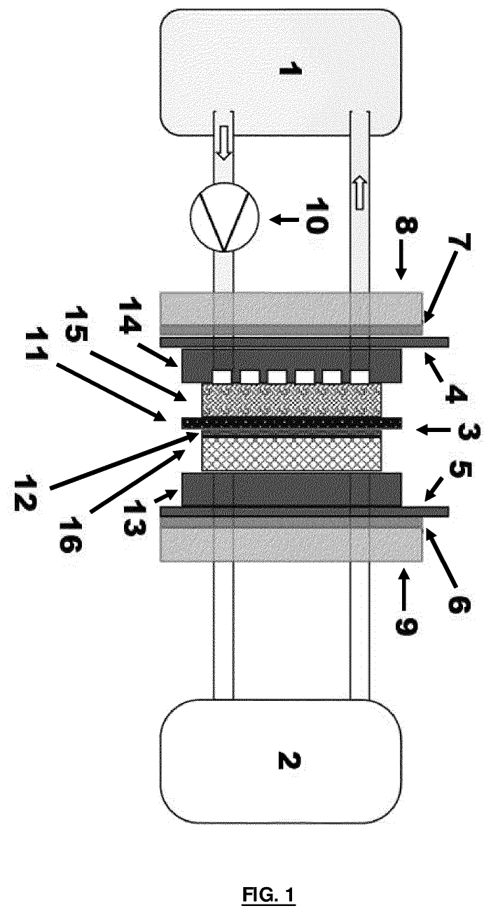

The redox flow battery used in the experiments is schematically depicted in FIG. 1 and was composed by the components indicated by the following reference numbers:
1—positive electrode electrolyte tank (catholyte tank);
2—negative electrode electrolyte tank (hydrogen tank);
3—cell;
4—current collector;
5—current collector;
6—isolating plate;
7—isolating plate;
8—end-plate;
9—end-plate;
10—pump;
11—membrane;
12—catalyst;
13—bipolar plate—flow field;
14—bipolar plate—flow field;
15—liquid diffusion electrode;
16—gas diffusion electrode;

The Mn-catholyte, 20 mL, was pumped into the cell at 50 mL/min flow rate at room temperature in Examples 1-7 and 150 mL/min in Example 8. Hydrogen gas flow was supplied only during discharge at a pressure of 1.5 bar. The electrochemical cell was composed by two end plates that sandwiched the rest of the components: two polypropylene isolating plates, two copper current collectors, bipolar plate flow fields (double serpentine type for cathode and interdigit for the anode side). A 2.5 mm thick thermally activated commercial graphite-felt (SGL-GFD 2.5 EA thermally activated) cathode with an active area of 5×5 cm² was used. Finally, a 5×5 cm² active area gas diffusion layer electrode with 0.5 mg/cm² Pt catalyst was used as anode (Quintech—BC-H100-05S).

Charge-discharge processes were carried out at 2 C, with respect to the nominal capacity of the catholyte, or specified in each case. The lower and upper potential limits were 0.6V and 1.75 V, respectively.

The cathodes to be analyzed were cleaned by immersion in deionized water and dried in air for at least 72 h after charge. The morphological and chemical characterization were performed in a FE-SEM, EDS (SEM JEOL IT300).

### Example 1

In this experiment, a H₂—Mn battery with 0.5M Mn²⁺ and a nominal capacity of 534 mAh was used. As catholyte, 20 mL of an aqueous solution with 0.5M MnSO₄, 0.75 M TiOSO₄, and 3M H₂SO₄ was used.

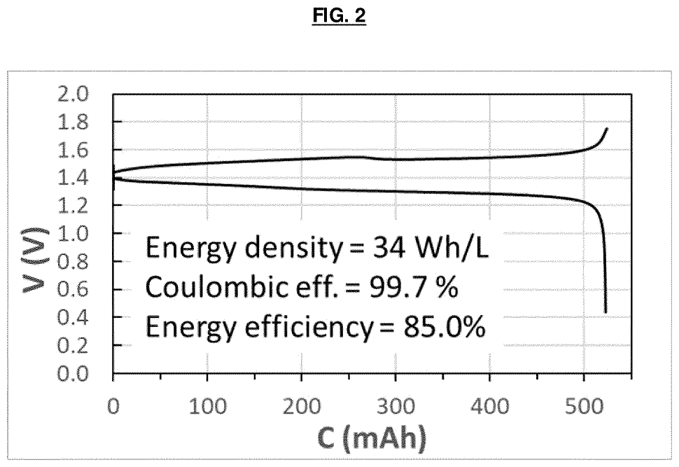

FIG. 2 shows the first cycle obtained. The discharge at a 30 mA/cm² current density delivered a capacity of 523 mAh, 97.6% with respect to the nominal capacity calculated considering Eq. 2 (reversible two-electron redox mechanism). The coulombic efficiency obtained was of 99.7%, demonstrating the good reversibility of the system.

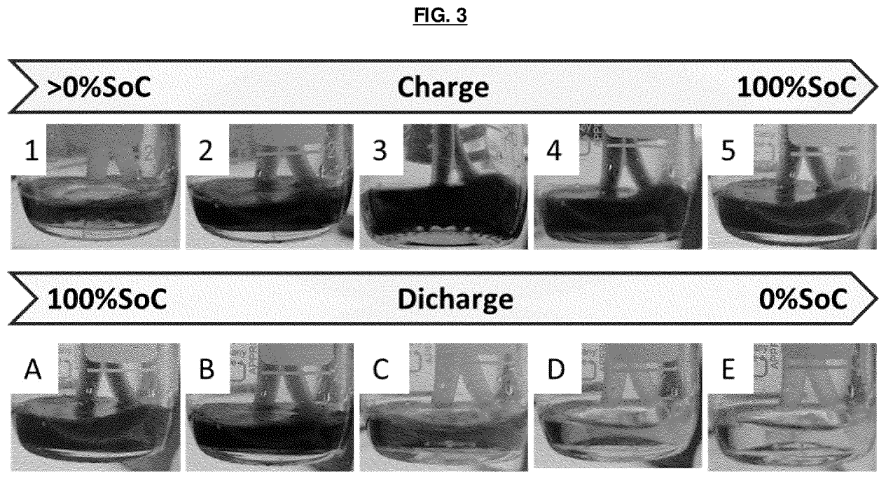

FIG. 3 shows the visual appearance of the Mn-based catholyte during the charge and discharge process. Notably, FIG. 3a depicts the electrolyte visual appearance from the beginning of the charge process (photo 1, SoC>0%) to 100% SoC (photo 5). The 100% SoC electrolyte appearance was visually homogeneous and opaque in agreement with the characteristics of a solid suspension. FIG. 3b depicts the electrolyte visual appearance during the discharge process from photo A (100% SoC) to photo E (0% SoC). The lack of solids at 0% SoC (photo E) served as visual evidence of the reversible MnO₂-suspension mechanism process with no irreversible precipitation of the charge product.

### Example 2

Example 1 was repeated but using 20 mL of an aqueous solution with 0.3M MnSO₄, 0.45 M TiOSO₄, and 3M H₂SO₄ as catholyte.

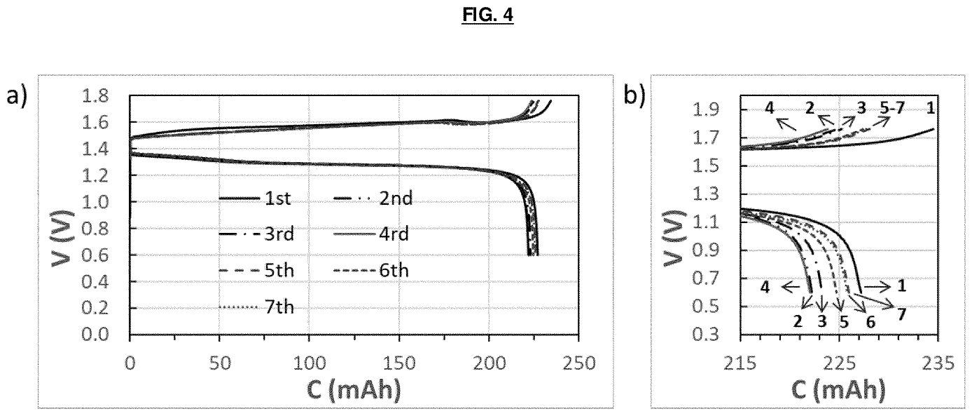

FIG. 4 shows the first 7 cycles obtained at 2 C (25 mA/cm²).

In table 1 are summarized the different performance parameters of each cycle.

TABLE 1

| | Cycle 1 | Cycle 2 | Cycle 3 | Cycle 4 | Cycle 5 | Cycle 6 | Cycle 7 |
|---|---|---|---|---|---|---|---|
| Capacity | 228 mAh | 223 mAh | 224 mAh | 222 mAh | 226 mAh | 225 mAh | 226 mAh |
| C retention | — | 100 | 100 | 100 | 101 | 101 | 101 |
| Q eff (%) | 96.9 | 99.1 | 99.2 | 99.3 | 99.2 | 99.0 | 99.3 |
| E eff (%) | 78.0 | 80.9 | 81.2 | 81.3 | 81.2 | 80.8 | 81.3 |

Excluding the first cycle, as it is not representative due to cell initial stabilization, the rest of the cycles showed an average discharge capacity of 224 mAh with negligible variations. No capacity fading was noted. Besides, the coulombic efficiency values above 99.1% demonstrated the good reversibility of the system. Finally, an energy efficiency with an average value of 81% was registered.

### Example 3 (Reference)

Example 2 was repeated but using a graphite-felt cathode not thermally activated (SGL-GFD 2.5 EA non-activated).

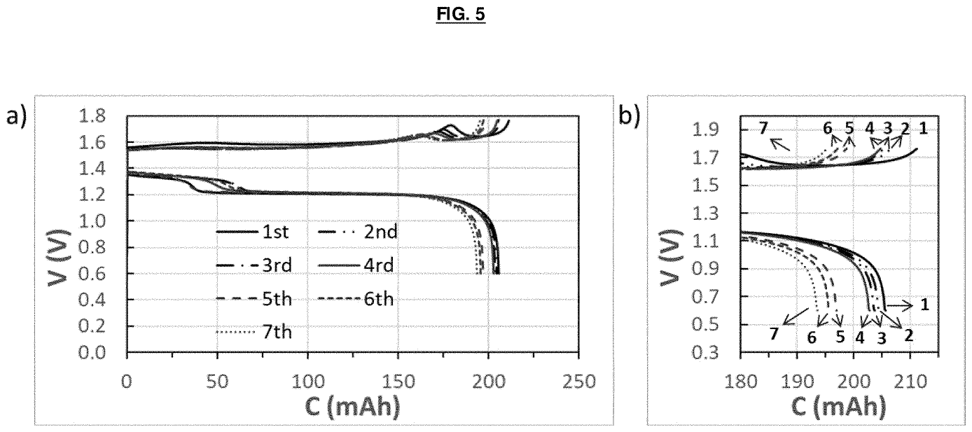

FIG. 5 shows the first 7 cycles obtained at 2 C (25 mA/cm²).

Table 2 summarizes the different performance parameters of each cycle.

TABLE 2

| | Cycle 1 | Cycle 2 | Cycle 3 | Cycle 4 | Cycle 5 | Cycle 6 | Cycle 7 |
|---|---|---|---|---|---|---|---|
| Capacity | 206 mAh | 205 mAh | 204 mAh | 203 mAh | 197 mAh | 194 mAh | 194 mAh |
| C retention | — | 100 | 99.5 | 99.0 | 96.1 | 94.6 | 94.6 |
| Q eff (%) | 97.5 | 99.1 | 99.2 | 99.2 | 99.2 | 99.2 | 85.1 |
| E eff (%) | 73.0 | 76.5 | 76.8 | 76.5 | 75.9 | 77.2 | 66.8 |

Excluding the first cycle, that was not representative due to cell initial stabilization, the rest of the cycles showed a decreasing discharge capacity towards cycling which implied a capacity retention of 94.6% at the 7^{th} cycle. This result was in good agreement with the statements made in the prior art, for example WO2017103578A1, regarding MnO₂ generation and precipitation. Besides, the average energy efficiency reached a lower value, 75%, with respect to the system according to Example 2.

### Example 4 (Reference)

Example 2 was repeated but using 20 mL of an aqueous solution with 0.3M MnSO₄ and 3M H₂SO₄ as catholyte. In other words, the catholyte was TiOSO₄-free.

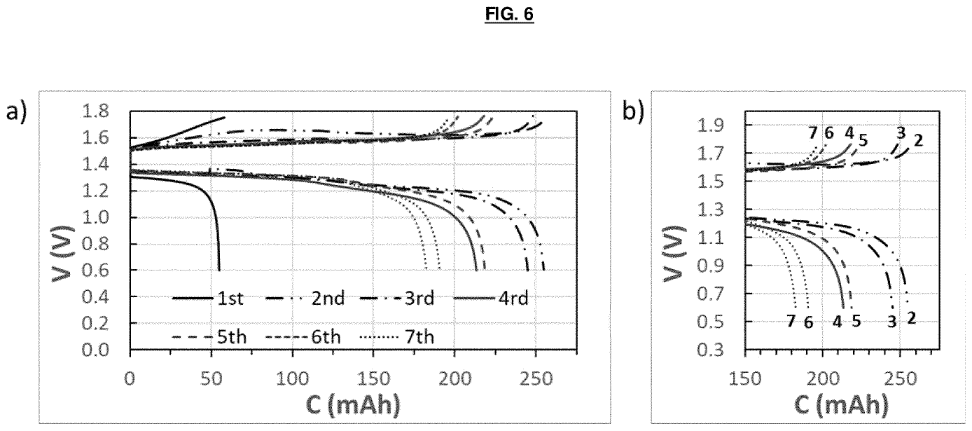

FIG. 6 shows the first 7 cycles of the battery obtained at 2 C (25 mA/cm²). Performance parameters are summarized in Table 3.

TABLE 3

| | Cycle 1 | Cycle 2 | Cycle 3 | Cycle 4 | Cycle 5 | Cycle 6 | Cycle 7 |
|---|---|---|---|---|---|---|---|
| Capacity | 55 mAh | 255 mAh | 245 mAh | 214 mAh | 218 mAh | 191 mAh | 183 mAh |
| C retention | — | 100 | 95.7 | 83.9 | 85.5 | 74.9 | 71.8 |
| Q eff (%) | 95.0 | 98.4 | 97.6 | 97.9 | 94.6 | 94.6 | 93.0 |
| E eff (%) | 71.7 | 75.0 | 74.9 | 78.3 | 76.7 | 76.7 | 75.4 |

Excluded the first cycle that was not representative due to cell initial stabilization, the rest of the cycles showed a highly variable performance and a rapid capacity loss starting from the second cycle and reaching 71.8% of capacity retention at the 7^{th} cycle. Voltage overpotential between charge and discharge profiles lead to energy efficiency values of 75.4%, significantly lower to the results of Example 2. This result is in good agreement with the statements made in the prior art, for example Javier Rubio-Garcia et Al. Hydrogen/manganese hybrid redox flow battery. J. Phys.: Energy, Vol. 1 (2019) 015006, regarding the instability of systems free of Ti⁴⁺ in the electrolyte.

### Example 5—Comparison Among Systems

To evaluate the different performances of the RFB according to the invention (Example 2), with the reference systems (Example 3 and 4—reference examples), a comparison at the 7^{th} charge/discharge cycle was made.

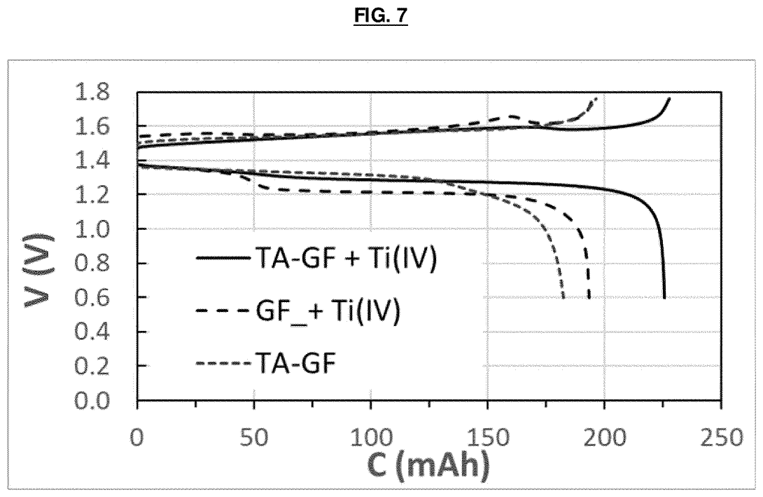

FIG. 7 summarizes the comparison: FIG. 7 reports the 7th charge/discharge of the systems. The RFB according to Example 2 is indicated as “TA-GF+Ti(IV)”, that according to Example 3 is indicated as GF+Ti(IV), and that according to Example 4 is indicated as “TA-GF”.

Table 4 summarizes the different parameters determined.

TABLE 4

| | TA − GF + Ti(IV) | GF + Ti(IV) | TA − GF |
|---|---|---|---|
| | (Ex. 2) | (Ex. 3) | (Ex. 4) |
| | Cycle 7 | Cycle 7 | Cycle 7 |
| Capacity | 226 mAh | 197 mAh | 183 |
| C retention | 101 | 96.1 | 71.8 |
| Q eff (%) | 99.2 | 99.2 | 93.0 |
| E eff (%) | 81.2 | 75.9 | 75.4 |

It was possible to note that the RFB according to Example 2 (TA-GF+Ti(IV)) delivered higher capacity values and capacity retention, which confirmed that the electrolyte charge was not blocked by precipitates when a MnO₂-suspension mechanism was promoted.

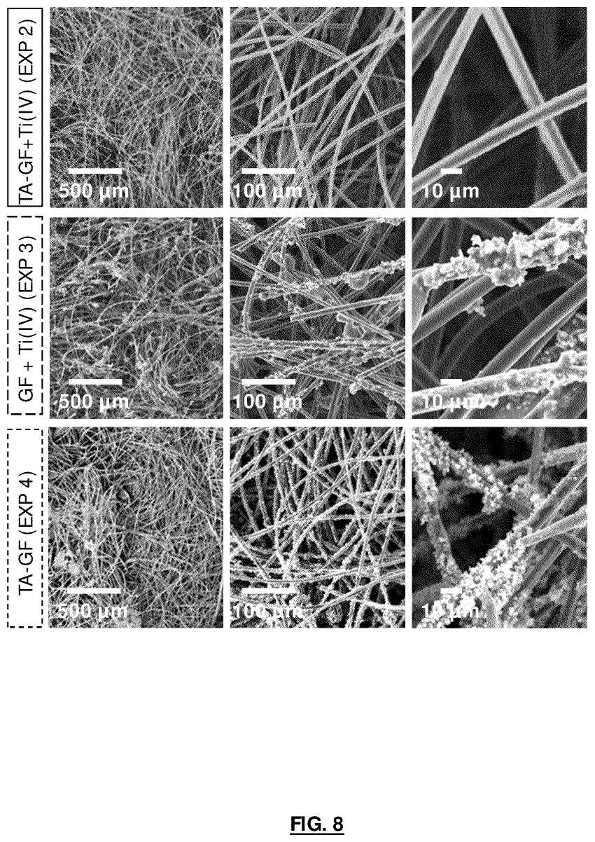

FIG. 8 shows FE-SEM micrographs at different augments of the electrodes in Examples 2, 3 and 4 after battery charging. The electrodes of reference Examples 3 and 4 show a relevant number of particles attached to the cathode fibers that are not present in the system combining the thermally-activated graphite-felt and Ti⁴⁺ in the electrolyte (Example 2, according to the invention). EDS analysis further confirmed the presence of Mn species on Example 3 (6.6%) and 4 (42.7%) electrodes whereas the amount of Mn on the electrode of the Example 2 was significantly lower (0.9%).

Table 5 summarizes the different parameters determined.

TABLE 5

| | C(%) | O(%) | P(%) | S(%) | Ti(%) | Mn(%) |
|---|---|---|---|---|---|---|
| TA-GF + Ti(IV) | 80.3 | 17.7 | 0.1 | 0.6 | 0.3 | 0.9 |
| (Ex. 2) | | | | | | |
| GF + Ti(IV) | 17.1 | 62.6 | 0.0 | 12.2 | 1.5 | 6.6 |
| (Ex. 3) | | | | | | |
| TA-GF | 15.9 | 39.8 | 0.0 | 1.6 | 3.0 | 42.7 |
| (Ex. 4) | | | | | | |

These results evidence the systems in which MnO₂ platting takes place during charge (TA-GF and GF+Ti(IV)) versus the system in which MnO₂ is not plated (TA-GF+Ti(IV)).

### Examples 6, 7 and 8

In Example 6, example 2 was repeated but using 20 mL of an aqueous solution with 1 M MnSO₄ 1.5 M, TiOSO₄, and 3 M H₂SO₄ as catholyte.

In Example 7, example 2 was repeated but using 20 mL of an aqueous solution with 1.5 M MnSO₄, 2M TiOSO₄, and 3 M H₂SO₄ as catholyte.

In Example 8, example 2 was repeated but using 20 mL of an aqueous solution with 2 M MnSO₄, 1 M TiOSO₄, and 2 M H₂SO₄ as catholyte, with a 150 mL/min flow.

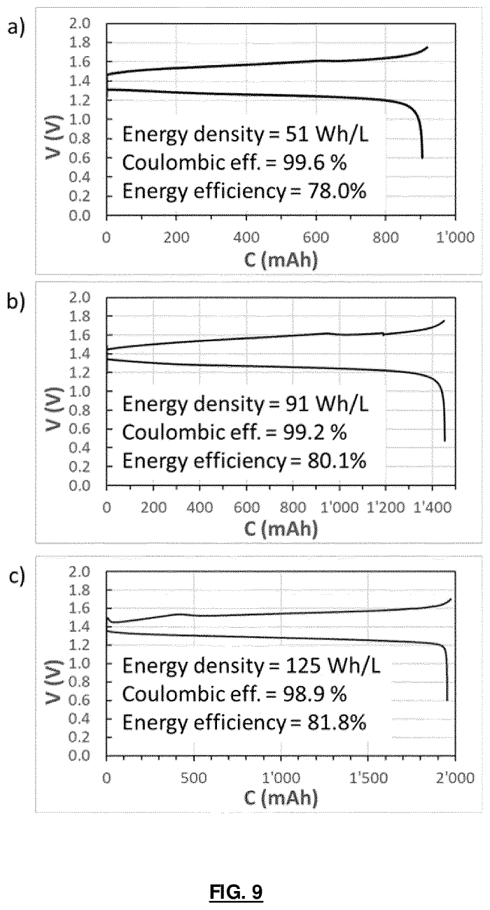

FIG. 9 depicts the charge/discharge cycle of the battery obtained. FIG. 9a shows the cycle obtained in Example 6 at 1 C (43 mA/cm²). The cell showed an energy density of 51.4 Wh/L at 1 M Mn²⁺, an energy density 55% higher in comparison to 33 Wh/L claimed in the prior art for 1e⁻ exchange H₂—Mn system (Eq 1—Javier Rubio-Garcia et al 2019 J. Phys. Energy 1 015006).

FIG. 9b shows the cycle obtained in Example 7 at 0.67 C (43 mA/cm²). The battery delivered 91 Wh/L energy density with a reversibility of 99.2% and 80.1% coulombic and energy efficiency, respectively.

FIG. 9c shows the cycle obtained in Example 8 at 0.25 C (22 mA/cm²). The battery delivered 125 Wh/L energy density with a reversibility of 98.9% and 81.8% coulombic and energy efficiency, respectively. These results demonstrate the high potential of this mechanism.

All the results demonstrated that the MnO₂-suspension mechanism was feasible at concentrated electrolytes, where competitive performances are reached.

### Example 9

In Example 9, example 2 was repeated but using 20 mL of an aqueous solution with 0.3 M MnSO₄ 0.45 M, SnCl₄, and 3 M H₂SO₄ as catholyte.

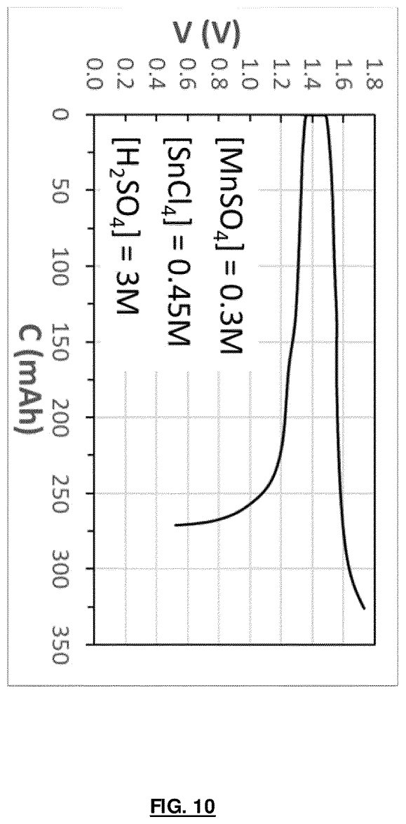

FIG. 10 depicts the charge/discharge cycle of the battery obtained at 1 C (43 mA/cm²). The cells shows a capacity utilization of 84.4% of the nominal capacity for two electron redox reaction (271 mAh/321 mAh) demonstrating that Sn⁴⁺ efficiently works as complexing agent according to the invention.

Example 10 to 11 In Example 10 to 11, performance of batteries containing the following electrolytes are compared: in Example 11, an electrolyte named as Sn-free (Ex. 11), 0.5 M MnSO₄ and 3 M H₂SO₄ in 20% acetonitrile aqueous solution was used. In Example 10, named as Sn(IV) (Ex. 10), electrolyte containing 0.5 M MnSO₄; 0.125 M Sn(IV); 3 M H₂SO₄ in 20% acetonitrile aqueous solution was used.

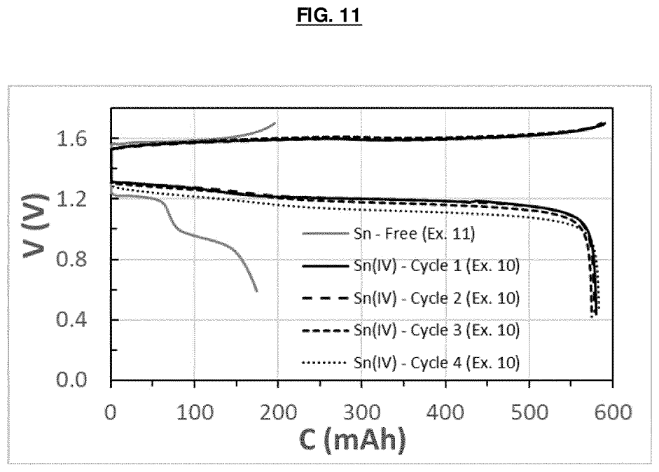

FIG. 11 compares the electrochemical behavior of two batteries. The first one depicts the behavior of the Sn-free (Ex. 11) electrolyte contains acetonitrile in absence of Sn(IV). In this case, the electrochemical reactions show limited performances, the charge process reaches the cutoff limit at 196 mAh (32% of nominal capacity), most probably blocked by the large quantity of solids deposited on system tubing and electrolyte tank generated from an uncontrolled Mn³⁺ disproportionation into MnO₂ solids and further detrimental effects. The discharge capacity reaches 173 mAh (28% of nominal capacity). The electrolyte named as Sn(IV)—(Ex. 10) Cycles 1 to 4, containing Sn ion, and acetonitrile, shows a reversible charge discharge profiles reaching 583 mAh capacity (95% of nominal capacity). These results demonstrate the role of Sn ion as complexing agent to exploit two-electron MnO₂ suspension mechanism.

1. A redox flow battery in which a positive electrode electrolyte and a negative electrode electrolyte are supplied to a battery cell including a positive electrode, a negative electrode, a membrane interposed between electrodes, to charge and discharge the battery, wherein:
said positive electrode electrolyte comprises at least one manganese ion and at least one complexing agent selected from the group consisting of: a titanium ion, a tin ion, a chromium ion, an aluminum ion, a vanadium ion, a cerium ion, or mixtures thereof;
said negative electrode electrolyte comprises at least one active redox species that couples with the manganese ion of the positive electrode electrolyte; and
said positive electrode is a thermally activated carbon-based electrode.

2. The redox flow battery according to claim 1, wherein said positive electrode electrolyte comprises said at least one manganese ion in a concentration of from 0.1 M to 4.2 M.

3. The redox flow battery according to claim 2, wherein said positive electrode electrolyte comprises said at least one manganese ion in a concentration of from 1 M to 3.5 M.

4. The redox flow battery according to claim 3, wherein said positive electrode electrolyte comprises said at least one manganese ion in a concentration of from 1.5 M to 3 M.

5. The redox flow battery according to claim 1, wherein in said positive electrode electrolyte the redox reaction of said at least one manganese ion is
Mn²⁺+2H₂O↔MnO₂+4H⁺+2e⁻.

6. The redox flow battery according to claim 1, wherein said positive electrode electrolyte comprises a manganese(IV)-containing species.

7. The redox flow battery according to claim 6, wherein said manganese(IV)-containing species is MnO₂.

8. The redox flow battery according to claim 1, wherein said positive electrode electrolyte comprises said at least a complexing agent in a concentration of from 0.1 M to 8 M.

9. The redox flow battery according to claim 8, wherein said positive electrode electrolyte comprises said at least a complexing agent in a concentration of from 0.25 M to 6 M.

10. The redox flow battery according to claim 9, wherein said positive electrode electrolyte comprises said at least a complexing agent in a concentration of from 0.5 M to 5 M.

11. The redox flow battery according to claim 1, wherein the molar ratio between said at least one manganese ion and said at least a complexing agent ranges from 0.1 to 2.

12. The redox flow battery according to claim 11, wherein the molar ratio between said at least one manganese ion and said at least a complexing agent ranges from 0.25 to 1.5.

13. The redox flow battery according to claim 1, wherein said at least a complexing agent comprises a titanium ion or a tin ion.

14. The redox flow battery according to claim 1, wherein said titanium ion is selected from the group consisting of: trivalent titanium ion (Ti³⁺) and tetravalent titanium ion (Ti⁴⁺ or TiO²⁺).

15. The redox flow battery according to claim 1, wherein said tin ion is selected from the group consisting of: divalent tin ion (Sn²⁺) and tetravalent tin ion (Sn⁴⁺).

16. The redox flow battery according to claim 1, wherein said tin ion is selected from the group consisting of: divalent tin ion (Sn²⁺) and tetravalent tin ion (Sn⁴⁺) and the positive electrode electrolyte comprises at least one solvation agent, preferably acetonitrile.

17. The redox flow battery according to claim 1, wherein said positive electrode electrolyte has a pH of from 0 to 2.

18. The redox flow battery according to claim 1, wherein said positive electrode electrolyte comprises at least one acid in a concentration equal to or lower than 4 M.

19. The redox flow battery according to claim 18, wherein said positive electrode electrolyte comprises at least one acid in a concentration equal to or lower than 3.5 M.

20. The redox flow battery according to claim 19, wherein said positive electrode electrolyte comprises at least one acid in a concentration equal to or lower than 3 M.

21. The redox flow battery according to claim 18, wherein said at least one acid is selected from the group consisting of: sulfuric acid, hydrochloric acid, phosphoric acid, diphosphoric acid, and nitric acid.

22. The redox flow battery according to claim 21, wherein said at least one acid is sulfuric acid.

23. The redox flow battery according to claim 1, wherein said positive electrode electrolyte comprises at least one anion selected from the group consisting of SO₄²⁻, Cl⁻, Br⁻, PO₄²⁻, P₂O₇⁴⁻ and NO₃⁻.

24. The redox flow battery according to claim 1, wherein said at least one active redox species of the negative electrode electrolyte is selected from the group consisting of: a proton, a nickel ion, a cobalt ion, an iron ion, a lead ion, a copper ion, a sulfur ion, a sulfide ion, a zinc ion, a titanium ion, a vanadium ion, a tin ion, a cerium ion, an iron ion, quinones derivatives thereof, anthraquinones or derivatives thereof, viologens or derivatives thereof, indigo or derivatives thereof, naphtalenediimide or derivatives thereof, diazaanthracenedione or derivatives thereof.

25. The redox flow battery according to claim 1, wherein said at least one active redox species of the negative electrode electrolyte has an E° of at least 0.6V lower than the E° of reaction:

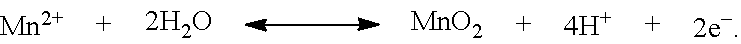

26. The redox flow battery according to claim 1, wherein said at least one active redox species of the negative electrode electrolyte is a proton and in said negative electrode electrolyte the redox reaction of said proton is

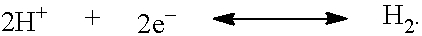

27. The redox flow battery according to claim 1, wherein said thermally activated carbon-based electrode is selected from the group of: a graphite-felt, a carbon felt, a graphite cloth, a graphite nanoparticle, a graphite nanofiber, a carbon cloth, a carbon nanotube, a carbon nanoparticle, or a carbon nanofiber thermally activated electrode.

28. The redox flow battery according to claim 1, wherein said thermally activated carbon-based electrode is a graphite-felt thermally activated electrode.

29. The redox flow battery according to claim 1, wherein said positive electrode is coupled with at least one flow-by type flow field.

30. The redox flow battery according to claim 29, wherein said flow-by type flow field includes a channel design selected from the group consisting of: single serpentine channel design, multiple serpentine channel design, and parallel channel design.

31. A method of storing electricity comprising the steps of:
a) providing a redox-flow battery according to claim 1;
b) electrically connecting said redox-flow battery to a power source.

32. A method of delivering electricity comprising the steps of:
a) providing a redox-flow battery according to claim 1;
b) electrically connecting said redox-flow battery to a load.

33. Use of a thermally activated carbon-based electrode in combination with at least one complexing agent selected from the group consisting of: a titanium ion, a tin ion, a chromium ion, an aluminum ion, a vanadium ion, a cerium ion, or mixtures thereof, for suppressing the precipitation of MnO₂ in an electrolyte comprising at least one manganese ion during the functioning of a redox flow battery in which a redox reaction of said manganese ion in said electrolyte is

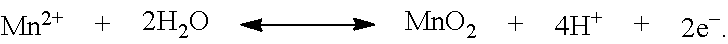

34. The use according to claim 33, wherein said thermally activated carbon-based electrode is selected from the group of: a graphite-felt, a carbon felt, a graphite cloth, a graphite nanoparticle, a graphite nanofiber, a carbon cloth, a carbon nanotube, a carbon nanoparticle, or a carbon nanofiber thermally activated electrode.

35. The use according to claim 33, wherein said thermally activated carbon-based electrode is a graphite-felt thermally activated electrode.

36. The use according to claim 33, wherein said complexing agent comprises a titanium ion or a tin ion.

37. The use according to claim 33, wherein said electrolyte comprises said at least one complexing agent in a concentration of from 0.1 M to 8 M.

38. The use according to claim 37, wherein said electrolyte comprises said at least a complexing agent in a concentration of from 0.25 M to 6 M.

39. The use according to claim 37, wherein said electrolyte comprises said at least a complexing agent in a concentration of from 0.5 M to 5 M.

40. The use according to claim 33, wherein the molar ratio between said at least one manganese ion and said at least a complexing agent ranges from 0.1 to 2.

41. The use according to claim 40, wherein the molar ratio between said at least one manganese ion and said at least a complexing agent ranges from 0.25 to 1.5.
